(19) United States
(12) Patent Application Publication
(10) Pub. No.: US 2010/0057347 A1
(43) Pub. Date: Mar. 4, 2010

(54) VEHICLE NAVIGATION DEVICE

(75) Inventors: Kenji Sugiyama, Utsunomiya-shi (JP); Yasuhiro Konishi, Kawagoe-shi (JP); Toshihiko Suzuki, Shimotsuga-gun (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/548,842

(22) Filed: Aug. 27, 2009

(30) Foreign Application Priority Data
Sep. 1, 2008 (JP) P2008-223784

(51) Int. Cl. G01C 21/36

(52) U.S. Cl. 701/204; 701/206

(57) ABSTRACT

A vehicle navigation device including a destination setting means that sets a destination; a route searching means that searches for a route to the destination that has been set by the destination setting means; and a search condition setting means that sets a specified search condition from a plurality of conditions that include a type of facility serving as a search object and an area serving as a search object, in which the route searching means, in the case of an input operation of a specified search condition being performed by the user, searches for a waypoint and a route thereof based on the search condition.

### BACKGROUND

1. Field of the Invention

The present invention relates to a vehicle navigation device, and in particular to searching the vicinity of a route from the current position to a destination.

Priority is claimed on Japanese Patent Application No. 2008-223784, filed Sep. 1, 2008, the content of which is incorporated herein by reference.

2. Description of Related Art

Conventionally, navigation devices for a vehicle such as an automobile are known to be provided with a vicinity searching function that performs searching for facilities in the vicinity of the current position by sequentially narrowing down in steps from large classifications.

Specifically, in the aforementioned vicinity searching function, after selecting a large classification such as shops and hotels, gas stations, parking lots and the like, narrowing down is performed that involves selecting a middle classification such as brand name or affiliation name, and further selecting a small classification such as business hours, service time, food genre and the like that are appended conditions. In the case of narrowing down the search object in this way, generally there are many input items compared to searches based on telephone number and facility name, and for reasons of safety the operation of setting the search conditions cannot be performed while driving.

For that reason, a vehicle navigation system has been proposed in which a user sets a detailed facility search condition in advance, and then registers this search condition by assigning it to any button on the display (for example, refer to Japanese Patent Application Publication No. 2004-77180).

In this case, since searching can only be performed in the vicinity of the current position, it has been difficult to create an effective travel plan and meet various needs while traveling. Conventionally there is known a navigation device that, in the case of the route to a destination having been set, performs searching of facilities with a search area on the route or in the vicinity of the destination/waypoint serving as the target (for example, refer to Japanese Patent Application Publication No. H09-33272 and Japanese Patent Application Publication No. 2000-234937). However, in this case, although it is possible to make a search area in the vicinity of the destination/waypoint or the route the search target, the search area becomes too large, and so further narrowing of the search area and additional search conditions become necessary, which results in the operation becoming complicated.

Furthermore, as a vehicle navigation device of this type, there is one which for example in the case of there being time to spare until the desired arrival time, searches for a facility in which the user is interested in among the facilities that exist until the destination and calculates a recommended route to reach the destination while efficiently visiting that facility (for example, refer to Japanese Patent Application Publication No. H11-304505).

With regard to a facility that is retrieved in the vicinity of a route, there is also a navigation device that compares the case of stopping by that facility and not stopping by and informs the user how much of a difference arises in the travel plan (for example, refer to Japanese Patent Application Publication No. 2008-45967).

There is also a system that is provided with a plurality of search modes that differ in terms of the facilities targeted for searching and the method of providing the results, and by providing a route that matches the user attribute information, is capable of catering to requests such as vague requests, varied requests, and requests that change over time (for example, Japanese Patent Application Publication No. 2007-205947).

Although the vehicle navigation devices outlined above are capable of searching in accordance with user attributes for facilities that can be efficiently visited to the extent possible in the midst of the facilities that the user wishes to visit being unclear, there is a high possibility of presenting the user with an enormous volume of information that is unneeded. For that reason, in the case of the user's needs being made explicit, there is the problem of a search result that matches the user's needs such as facilities that user wishes to stop by or the timing of making such a stop not being obtained due to the large volume of information.

The present invention has as its aim to provide a vehicle navigation system that can search for a route that enables the user to stop by a facility matching the user's needs in a desired area and can reduce the amount of operation when searching for facilities.

### SUMMARY

An aspect of the present invention is to provide a vehicle navigation device provided with: a destination setting means that sets a destination; a route searching means that searches for a route to the destination that has been set by the destination setting means; and a search condition setting means that sets a specified search condition from a plurality of conditions that include a type of facility serving as a search object and an area serving as a search object, in which the route searching means, in the case of an input operation of a specified search condition being performed by the user, searches for a waypoint and a route thereof based on the search condition.

According to the aspect of the present invention, by setting a specified search condition with the search condition setting means from the plurality of conditions that include a type of facility serving as a search object and an area serving as a search object, and selecting this set search condition, it is possible to search for a waypoint and a route thereof based on the search condition. For this reason, particularly in the case of a user's needs being made explicit, it is possible to reduce the amount of operation during searching. Also, since the search condition includes the type of facility serving as a search object and an area serving as a search object, it is possible to search for only a facility in a desired area as a waypoint. As a result, it is possible to accurately and rapidly search for a waypoint and the route thereof that are more in accordance with the user's needs.

Also, as a result of searching with the facility information searching means, in the case of there being no facilities that agree with the search condition in the facility information that is stored in the facility information storing means, it is possible to search for facility information of facilities that can by substituted by the substitute facility searching means, for example, facility information of facilities in another area near the route until the destination, or facilities of a similar type, and it is possible to search for a waypoint and route with the route searching means based on the substitute facility information that is this retrieved facility information. That is, in the present embodiment, even in the case of there not being a facility that matches the user's needs, it is possible to accurately and rapidly search for a facility that is closest to the user's needs and set a route with that facility as a waypoint.

Moreover, based on the estimated time of arrival at a waypoint calculated by the estimated time of arrival calculating means and the business hours information of the facility stored in the business hours storing means, in the case of the business hours determining means determining that a facility cannot be arrived at during the business hours of the facility, the substitute facility searching means searches, for example, for a facility that can be arrived at during business hours as a substitute facility. Based on this search result, it is possible to set a waypoint and a route thereof with the route searching means. Therefore, it is possible to perform setting of a waypoint that corresponds to the business hours of the facility, and as a result, it is possible to achieve an improvement of the merchantability.

Furthermore, because it is possible to switch the area to be searched via the search area switching means, it is possible to readily switch the area that is set as the search condition to a desired area, and accordingly it is possible to achieve a further improvement of the merchantability.

Still further, based on the arrival cost that is calculated by an arrival cost calculating means, when highlighting the display of a specified area with a display control means, for example, by highlighting in steps with different colors or shades the condition of an area with a low arrival cost due to the time to arrival being short or the condition of an area with a high arrival cost, the user is capable of easily recognizing the condition of an area with a lower arrival cost or the condition of an area with a higher arrival cost. Therefore, it is possible to perform efficient route searching.

In addition, as the timing to stop by a waypoint, by simply inputting, for example, “soon”, “later” or the like via a stop-by timing input means, the user is able to automatically set the area of the vicinity of the current position in the case of “soon” and the area of the vicinity of the destination in the case of “later” as the search area by the search area setting means. Therefore, it is possible to achieve an improvement in usability.

### BRIEF DESCRIPTION OF THE DRAWINGS

FIG. 1 is a schematic block drawing of the vehicle navigation device in accordance with the first embodiment.

FIG. 2 is a drawing that shows an example of the vicinity search screen in the first embodiment.

FIG. 3 is a drawing that shows the search in progress screen in the first embodiment.

FIG. 4 is a drawing that shows the result display screen in the first embodiment.

FIG. 5 is a drawing that shows an example of the vicinity search screen in the first embodiment.

FIG. 6 is a drawing that shows the state of the edit button of the vicinity search screen having been selected in the first embodiment.

FIG. 7 is a drawing that shows an example of the search condition button selection screen in the first embodiment.

FIG. 8 is a drawing that shows an example of the search condition display screen prior to changing a setting in the first embodiment.

FIG. 9 is a drawing that shows an example of the search method selection screen in the first embodiment.

FIG. 10 is a drawing that shows an example of the search condition display screen after changing the search method in the first embodiment.

FIG. 11 is a drawing that shows an example of the search object selection screen in the first embodiment.

FIG. 12 is a drawing that shows an example of the small classification selection screen in the first embodiment.

FIG. 13 is a drawing that shows an example of the search condition display screen after changing the search object in the first embodiment.

FIG. 14 is a drawing that shows an example of the screen notifying use of a substitute facility based on the search condition in the first embodiment.

FIG. 15 is a drawing that shows an example of the result display screen of substitute facilities based on the search condition in the first embodiment.

FIG. 16 is a flowchart of the substitution process based on the search condition in the first embodiment.

FIG. 17 is a drawing that shows an example of the vicinity search screen corresponding to FIG. 5 in the description of the substitution process based on business hours.

FIG. 18 is a drawing that shows an example of the screen notifying used of a substitute facility based on business hours in the first embodiment.

FIG. 19 is a drawing that shows an example of the result display screen of substitute facilities based on business hours in the first embodiment.

FIG. 20 is flowchart of the substitution process based on business hours in the first embodiment.

FIG. 21 is a drawing that shows an example of the edit screen in the first modification of the first embodiment.

FIG. 22 is a drawing that shows an example of the edit screen in the second modification of the first embodiment.

FIG. 23 is a drawing that shows an example of the edit screen in the third modification of the first embodiment.

FIG. 24 is a block drawing that corresponds to FIG. 1 in the second embodiment.

FIG. 25 is a drawing that corresponds to FIG. 21 in the second embodiment.

FIG. 26 is a flowchart of the highlighting process in the second embodiment.

FIG. 27 is a block drawing that corresponds to FIG. 1 in the third embodiment.

FIG. 28 is a drawing that corresponds to FIG. 25 in the third embodiment.

FIG. 29 is a flowchart of the search method conversion process based on the stop-by timing in the third embodiment.

### DESCRIPTION OF EMBODIMENTS

Next, a vehicle navigation device in accordance with the first embodiment of this invention shall be described with reference to the drawings.

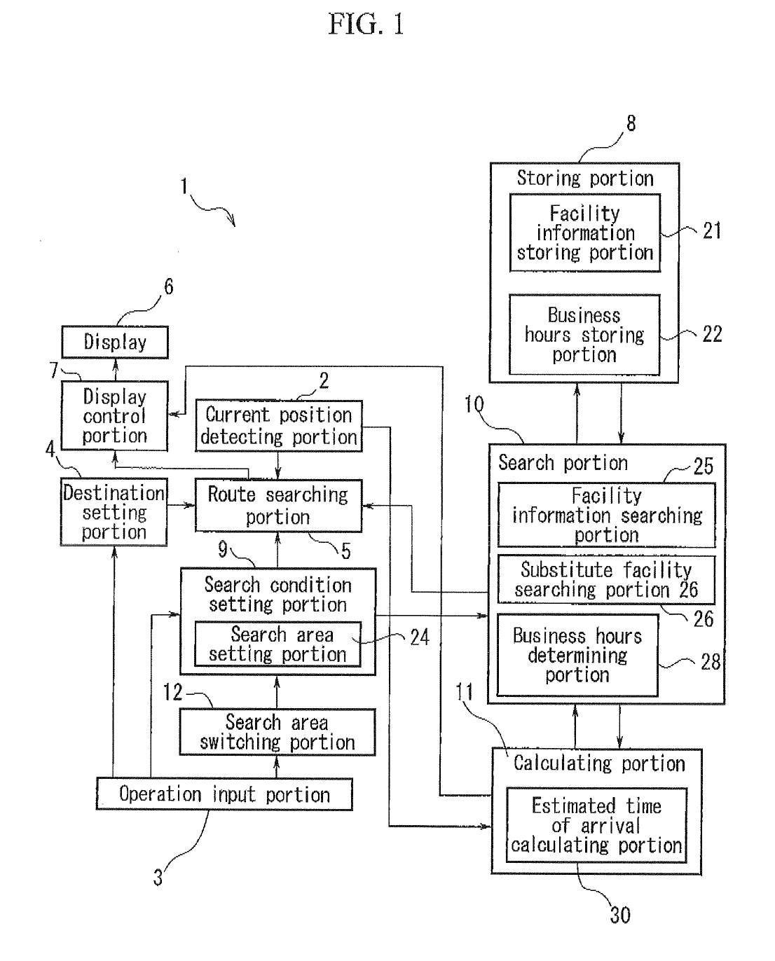

A vehicle navigation device 1 of the first embodiment is a navigation device that is mounted in a vehicle such as an automobile and can perform route guidance and the like from the current position to a destination. As shown in FIG. 1, the navigation device 1 is provided with a current position detecting portion 2, an operation input portion 3, a destination setting portion 4, a route searching portion 5, a display 6, a display control portion 7, a storing portion 8, a search condition setting portion 9, a search portion 10, a calculating portion 11, and a search area switching portion 12.

The current position detecting portion 2 is equipped with a GPS receiver (not shown), a vehicle speed sensor (not shown), and a gyroscope sensor (not shown). The GPS receiver receives positioning signals such as global position system (GPS) signals for working out the position of a vehicle using satellites and differential GPS (DGPS) signals for improving the positioning accuracy by correcting errors of GPS signals using for example a suitable base station. The vehicle speed sensor detects the speed of the vehicle (vehicle speed). The gyroscope sensor detects the heading of the vehicle in a horizontal plane and the inclination angle with respect to the perpendicular direction (for example, the inclination angle of the front-to-rear directional axis of the vehicle with respect to the perpendicular direction and the yaw angle that is the angle of rotation of the vehicle's center of gravity about the vertical axis), and the amount of change of the inclination angle (for example, the yaw rate). The current position detecting portion 2 computes the current position of the vehicle by the received positioning signal or by autonomous navigation calculation processing based on detection signals, such as the vehicle speed and yaw rate. The current position detecting portion 2 outputs the current position of the vehicle that has been computed to the route searching portion 5 and the calculating portion 11.

The operation input portion 3 is a user interface such as a joystick that is provided in a protruding manner on the instrument panel of the vehicle or a touch panel that is arranged on the display, and allows the selection and determination of a plurality of destinations or waypoints that are displayed on the display 6. Then, the information of the input result to the operation input portion 3 is output to the destination setting portion 4, the search condition setting portion 9, and the search area switching portion 12.

The destination setting portion 4 is a portion that sets a destination based on the input result of the operation input portion 3 mentioned above. The information of the destination that has been set by this destination setting portion 4 is output to the route searching portion 5.

Based on road data and the information of the destination, the route searching portion 5 sets a route from the current position of the vehicle to the destination, and outputs image information to which processing such as map matching has been applied to the display control portion 7. Road data is constituted by nodes and links as position information that is stored in a map database that is not illustrated. The target information is output from the detection result of the current position detecting portion 2 and the destination setting portion 4. Moreover, the route searching portion 5 sets a route to a destination with a facility that has been retrieved by the search portion 10 serving as a waypoint. The set route information to the destination including the waypoint is output to the calculating portion 11 and the display control portion 7.

The display 6 includes a liquid crystal panel, and control of the display content is performed by the display control portion 7. An image is displayed on this display 6 in which the current position and destination of the vehicle, and the route between the current position and the destination are superimposed on a map of an appropriate scale based on control commands of the display control portion 7.

The storing portion 8 is equipped with a facility information storing portion 21 and a business hours storing portion 22.

The facility information storing portion 21 stores point of interest (POI) data that consists of a plurality of pieces of information that are mutually associated and listed. For example, facility information includes genre, type of facility such as large classification and small classification, facility name such as a store, location information such as the road and intersection that the facility (shop or the like) is adjacent to, distance information from the current position of the vehicle to that facility, area information in which that facility is included among a plurality of areas that are set between the current position of the vehicle and destination, and additional information related to the facility (shop and the like). The facility information storing portion 21 is constituted by a rewritable storage media, such as a hard disk drive (HDD) or random access memory (RAM), and updating and calling up of POI data are performed by an ECU that is not illustrated.

Here, as for the aforementioned plurality of areas, the space between the current position and the destination may be divided at each of a plurality of ranges. For example, the route from the current position of the vehicle to the destination that has already been set is divided every predetermined distances, and a range of a predetermined width can be set as the aforementioned area centered on this divided route. Also, as the location information of a facility, position information such as latitude and longitude that is included in the map data and road information such as nodes and links can be suitably used.

In the business hours storing portion 22 are stored the business hours, more specifically, the opening time and closing time, of each facility that is stored in the facility information storing portion 21.

The storing portion 8 outputs storage information of the facility information storing portion 21 and the business hours storing portion 22 to the search portion 10 according to a request from the search portion 10.

The search condition setting portion 9 is a portion that combines a classification condition of a specific facility (hereinbelow referred to as the search object) and an area condition (hereinbelow referred to as the search method) and sets and stores the combination as a search condition. When the selection/determination of the aforementioned search condition is performed by the operation input portion 3, the information of the search condition is output to the search portion 10. Moreover, the search condition setting portion 9 is equipped with a search area setting portion 24. Note that a plurality of search conditions set by the search condition setting portion 9 can be respectively displayed on the search screen of the display 6.

The search area setting portion 24 performs setting of the search method of the abovementioned search condition based on the output of the operation input portion 3. Among the plurality of search conditions that are set by the search condition setting portion 9, the search target is set based on the input result of the operation input portion 3, and the search method is set based on the set result of the search area setting portion 24.

The search portion 10 is equipped with a facility information searching portion 25, a substitute facility searching portion 26, and a business hours determining portion 28.

The facility information searching portion 25 searches for facility information that agrees with the search condition from the stored information of the storing portion 8 based on the information on the search condition output from the search condition setting portion 9.

In the case that facility information that agrees with the search condition that was selected/determined by the user cannot be found by the facility information searching portion 25, the substitute facility searching portion 26 searches for a substitutable facility, that is, a facility with conditions close to the search conditions, from the stored information in the storing portion 8. Here, a facility with conditions close to the search conditions means a facility in an area adjacent to the searched area, or in terms of facility classification, a facility in which only a comparatively small classification differs such as a gas station of chain A and a gas station of chain B.

Then, in the case of a determination that all facilities that agree with the search condition cannot be reached during business hours as a result of a determination by the business hours determining portion 28 described below, the substitute facility searching portion 26 searches from the stored information of the storing portion 8 for a facility that can be reached within its business hours as a substitute facility. Also, in the substitute facility searching portion 26, it is possible to select via the operation input portion 3 whether or not to consider the determination result of the business hours determining portion 28.

Based on the calculation result of the calculating portion 11, the business hours determining portion 28 determines whether or not it is possible to arrive at the facility searched by the facility information searching portion 25 during its business hours and outputs the determination result to the substitute facility searching portion 26.

The calculating portion 11 is provided with an estimated time of arrival calculating portion 30.

The estimated time of arrival calculating portion 30 computes presumed time until arrival at the waypoint from the current position of the vehicle based on the information on the route until the waypoint output from the route searching portion 5, and computes the estimated time of arrival from this presumed time. Then, the calculating portion 11 outputs the information on the estimated time of arrival computed by the estimated time of arrival calculating portion 30 to the search portion 10.

The search area switching portion 12, based on an input result to the operation input portion 3, switches the area in which to search for a facility, that is, switches the search method among the search condition. The information of the search method switched by the search area switching portion 12 is output to the search condition setting portion 9. Thereby, the switched search method is set as the search condition in the search area setting portion 24 of the search condition setting portion 9.

The vehicle navigation device 1 in the first embodiment is provided with the composition mentioned above. Next, an example of movement of the vehicle navigation device 1 shall be explained with reference to the drawings. Note that the following example of the display screen of the vehicle navigation device 1 shows the case of a right-hand drive vehicle.

### [Process During Searching]

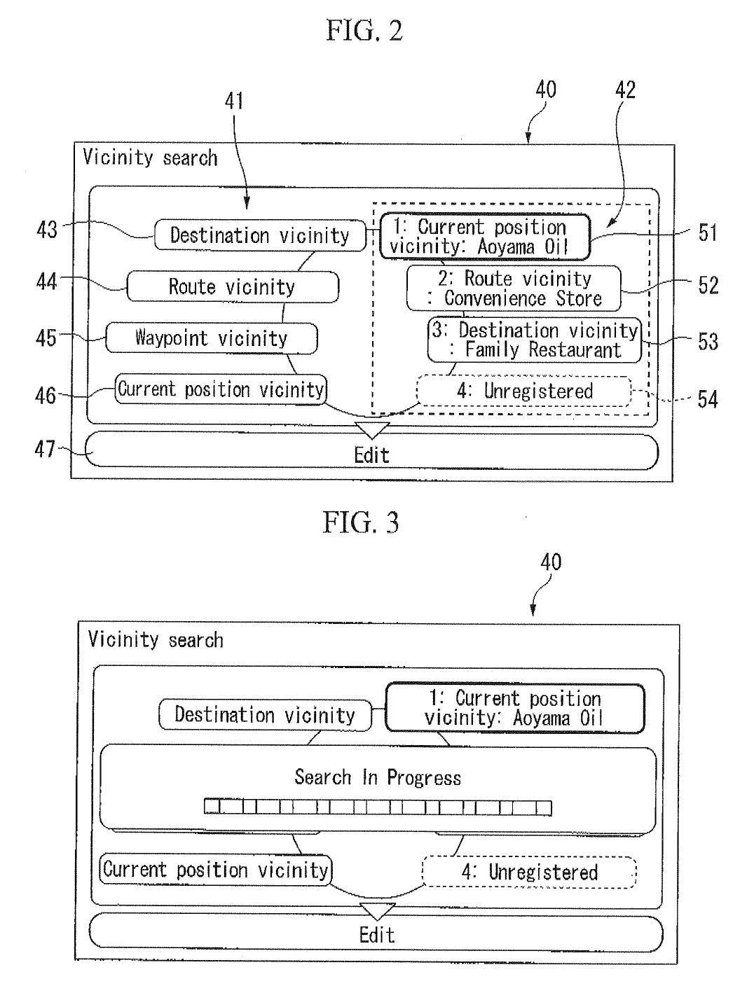

First, if an operation input for starting a vicinity search is performed by the user via the operation input portion 3 while the vehicle is travelling along a route toward a destination, the display control portion 7 will display the vicinity search screen 40 on the display 6, as shown in FIG. 2.

Here, a basic search button group 41 for vicinity searching is displayed in the region left of the center of this vicinity search screen 40, and an extended search button group 42 for vicinity searching is displayed in the region to the right of the center that is easier for the driver to operate in a right-hand drive vehicle (the region of the dashed line in FIG. 2). The basic search button group 41 is provided with a destination vicinity button 43, a route vicinity button 44, a waypoint vicinity button 45, and a current position vicinity button 46 that narrow down only the search method. Operating any button of the basic search button group 41 causes a button not illustrated to appear for selecting the search target not illustrated (genres, large classification, small classification, and the like), so as to perform narrowing of the search condition in stages. Note that the functions that are assigned to the buttons of the basic search button group 41 normally are set so that they cannot be edited.

On the other hand, the extended search button group 42 of FIG. 2 is provided with first to third search conditions buttons 51 to 53 in which search conditions that consist of a combination of the search method and search object can be set, and a fourth search condition button 54 with a search condition that is unregistered. That is, four kinds of search conditions can be set in this extended search button group 42 of FIG. 2. In the case of the extended search button group 42 of FIG. 2, a search condition in which the search method is the current position vicinity and the search object is Aoyama Oil is assigned to the first search condition button 51. A search condition in which the search method is the route vicinity and the search object is a convenience store is assigned to the second search condition button 52. A search condition in which the search method is the destination vicinity and the search object is a family restaurant is assigned to the third search condition button 53. Note that an edit button 47 described in detail below is shown at the bottom of the vicinity search screen 40.

When the first search condition button 51 of the extended search button group 42 mentioned above is selected by the user and the determination is input, a search-in-progress screen is displayed by the display control portion 7 (refer to FIG. 3). Also, during this time the aforementioned search condition is output from the search condition setting portion 9 to the search portion 10, and facilities that match the search condition, that is Aoyama Oil in the vicinity of the current position, are searched for in the stored information of the storing portion 8.

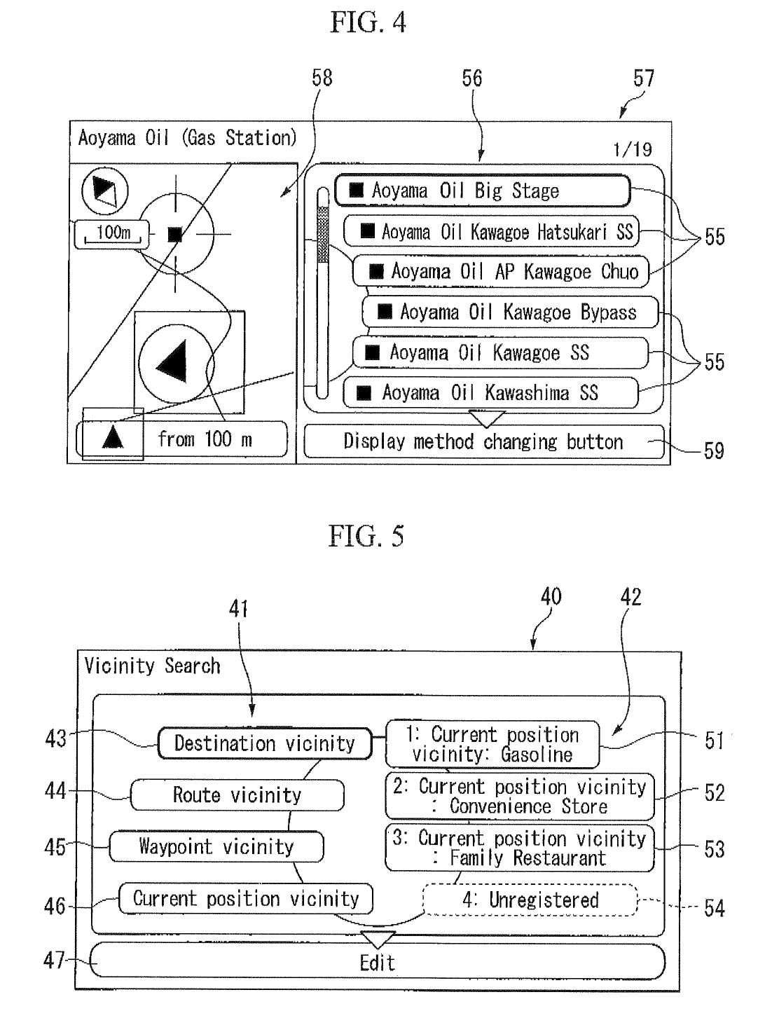

When a facility matching the search condition is found, the route from the current position of the vehicle to that facility is set by the route searching portion 5. As shown in FIG. 4, in the result display screen 57 are displayed a search result button group 56 that consists of a list of search result buttons 55 associated with route information, and a route information display portion 58. When a search result button 55 is selected by the user, the route information associated with that search result button 55 is displayed in the route information display portion 58. Also, when a determination input is made on a search result button 55 that has been selected by the user, that facility is set as a waypoint, and route guidance is started in accordance with the route information.

Here, the display screen 57 of FIG. 4 shows the case where the first search condition button 51 is selected in the vicinity search screen 40 of FIG. 2. In each search result button 55, the branch names of Aoyama Oil in the vicinity of the current position are shown as facility names, and “Aoyama Oil (gas station)” that is a common facility classification is displayed at the top portion of the result display screen 57. Note that the result display screen 57 of FIG. 4 shows the case of the search result button group 56 shown on the right side of the screen, and the route information associated with the search result button 55 that is currently selected, that is, a map on which is superimposed the current position of the vehicle, the waypoint, and the destination, shown on the left side of the screen. However, the layout of this result display screen 57 is not limited to that shown in FIG. 4, and for example may be configured to be changeable by providing a display method changing button 59 (refer to FIG. 4) or the like.

### [Process During Editing of Search Condition]

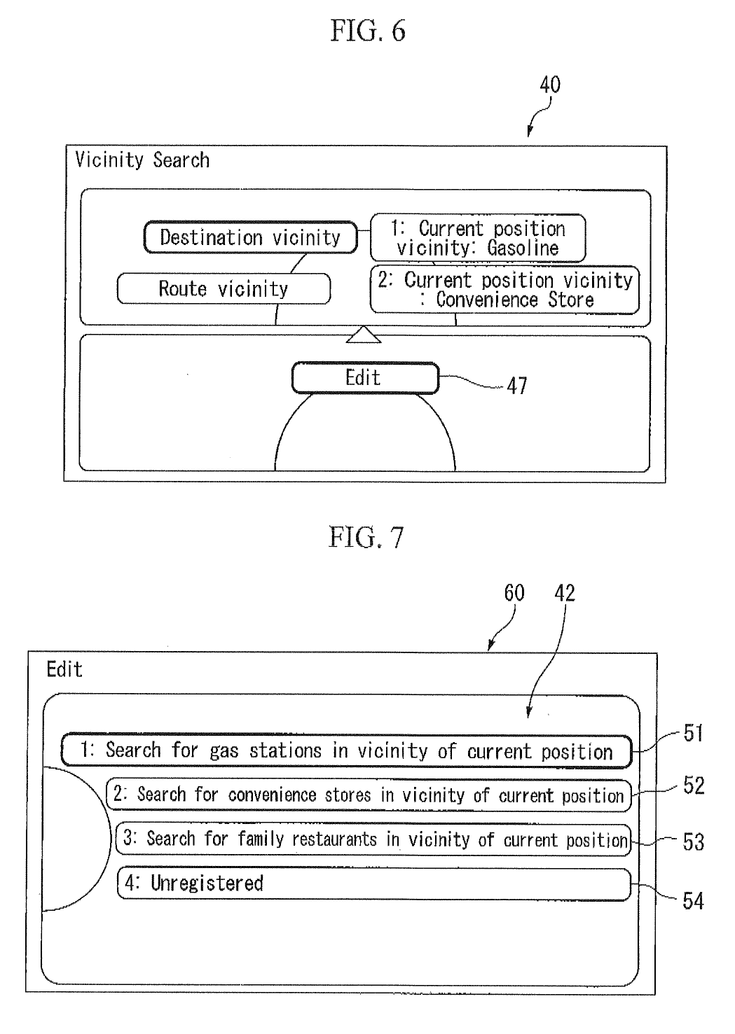

Next, the process at the time of editing of the search conditions that can be set to the first to fourth search condition buttons 51 to 54 mentioned above shall be explained. First, from the state of a button such as the destination vicinity button 43 being selected by the user in the vicinity search screen 40 shown in FIG. 5, the edit button 47 that is shown at the lower portion of the vicinity search screen 40 is selected by cursor movement or the like (refer to FIG. 6). When this selection (determination input) is made, as shown in FIG. 7, a search condition button selection screen 60 is displayed in which the extended search button group 42 that consists of the first search condition button 51 to the fourth search condition button 54 is enlarged.

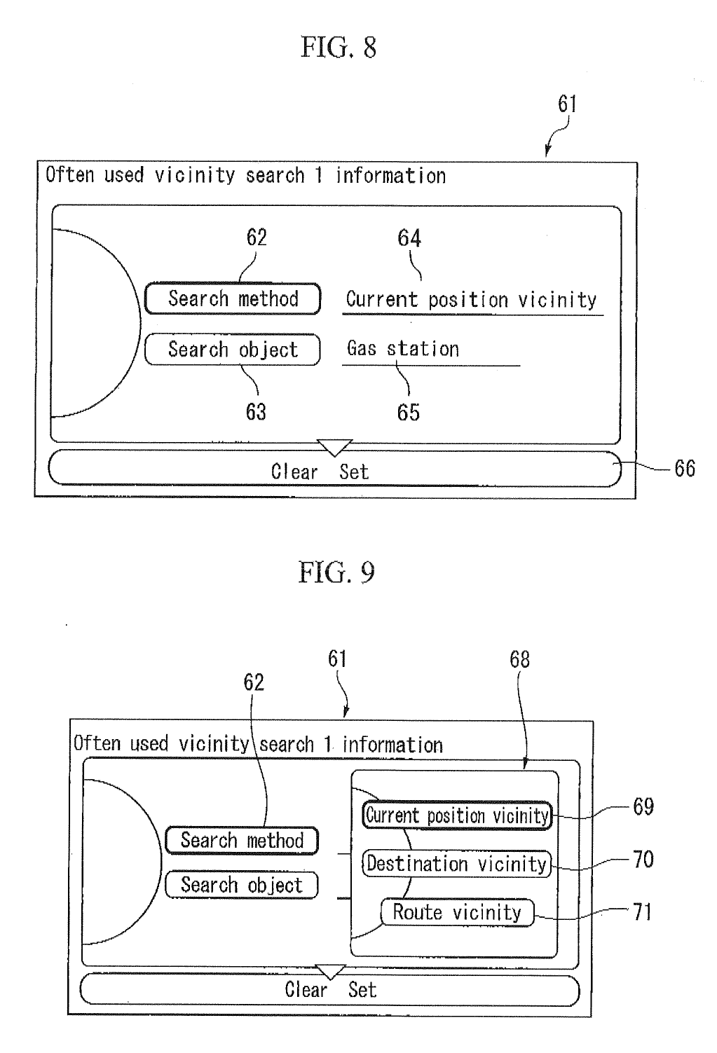

In the search condition button selection screen 60, any one button among the first search condition button 51 to the fourth search condition button 54 is selected (FIG. 7 shows the case of selecting the first search condition button 51), and the determination is input. When this happens, as shown in FIG. 8, a search condition display screen 61 of any of the first search condition button 51 to the fourth search condition button 54 that was selected is displayed. Here in the search condition display screen 61 are displayed a search method edit button 62 and a search object edit button 63, and a search method display portion 64 that displays the condition of the search method that is currently set is provided to the side of the search method edit button 62, and a search object display portion 65 that displays the condition of the search object that is currently set is provided to the side of the search object edit button 63. Also, at the bottom portion of the search condition display screen 61, a clear/set button 66 is provided.

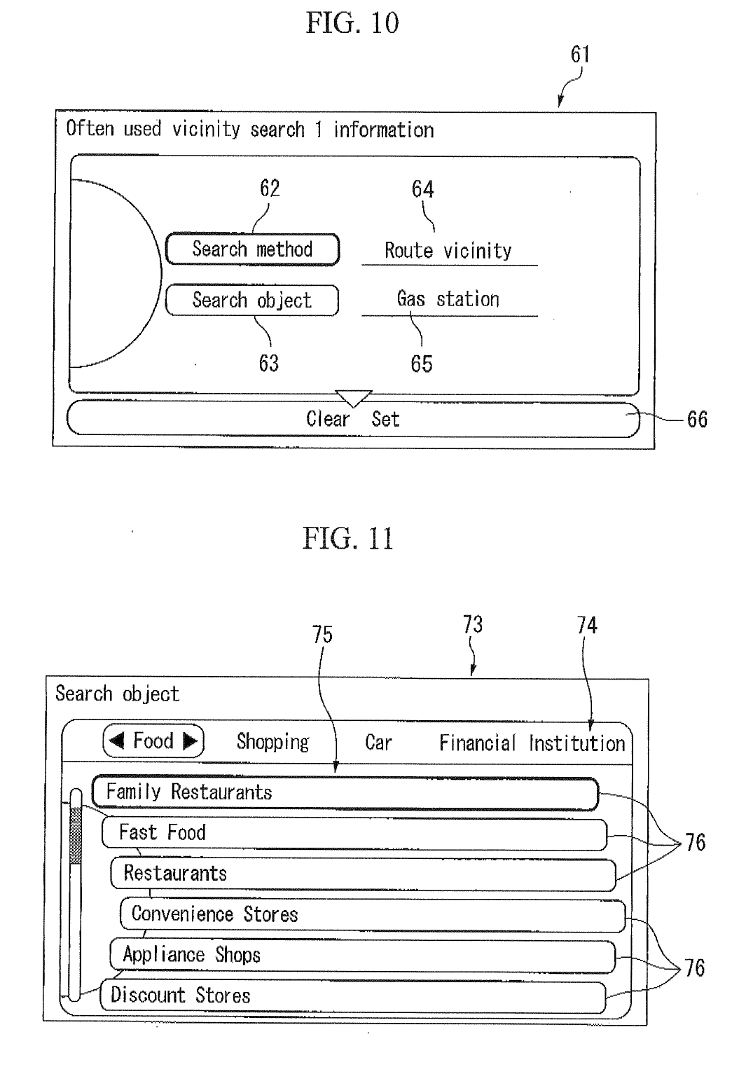

When for example the search method edit button 62 is selected and determination input is performed, a search method selection screen 68 shown in FIG. 9 is superimposed on the search condition display screen 61 as a separate frame. In this search method selection screen 68 are shown a current position vicinity button 69, a destination vicinity button 70, a route vicinity button 71 to which respective search methods have been assigned. In the case of the search method selection screen 68 shown in FIG. 9, since the condition prior to editing is “current position vicinity” (refer to FIG. 8), the state shown is that of the current position vicinity button 69 being selected. When the cursor is moved from this state and, for example, the route vicinity button 71 is selected and a determination input is performed, as shown in FIG. 10, “Route Vicinity” is set as the search method condition, and “Route Vicinity” is shown in the search method display portion 64.

Subsequently, if the search object edit button 63 is selected by the user and the determination is input, the search object selection screen 73 shown in FIG. 11 will be displayed. The search object selection screen 73 is provided with a genre selection portion 74 for selecting the genre such as “Food”, “Shopping”, “Car”, “Financial Institution” and the like, and a large classification selecting portion 75 for selecting the large classification (sub-genre) in the genre selected by this genre selecting portion 74.

If, for example, “Food” of the genre selecting portion 74 is selected, the large classification relating to “Food” is narrowed down, and large classification selection buttons 76 to which are assigned “Family Restaurants”, “Fast Food”, “Restaurants”, and the like that are the narrowed down result are listed. In addition, when using a joystick as the operation input portion 3, in the example of FIG. 11, tilting it left or right will cause the cursor of the genre selecting portion 74 to move left or right, while tilting it up or down will cause the cursor of the large classification selecting portion 75 to move up or down.

And if the genre and large classification are respectively selected by the user and the determination is input, a small classification selection screen 77 for selecting a small classification such as the chain or brand of the facility is displayed.

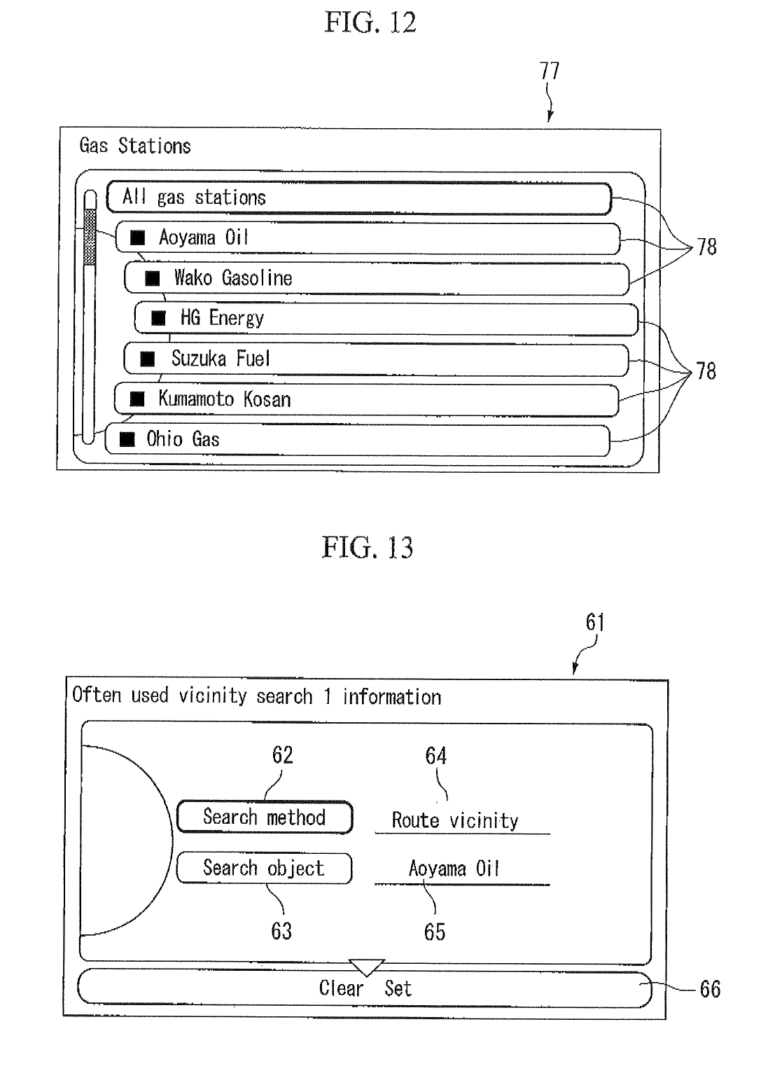

Here, for example, when the genre “car” and the large classification “gas station” are respectively selected and the determination is input, as shown in FIG. 12, brand selection buttons 78 of gas stations are listed in the small classification selection screen 77. Then, for example, when the brand selection button 78 “Aoyama Oil” is selected and the determination is input, “Aoyama Oil” is set as the search target, and as shown in FIG. 13, the search condition display screen 61 is displayed that shows “Aoyama Oil” in the search object display portion 65.

When it is confirmed by the user that there are no errors in the displayed content of the search condition display screen 61, and the clear/set button 66 is selected and the determination is input, the search condition is set as the displayed content of the search condition display screen 61, and the editing process of the search condition is completed. In addition, if the brand selection button 78 of “all gas stations” of FIG. 12 is selected and the determination input, the large classification “gas station” will be set as the search object condition.

### [Substitution Process Based on Search Condition]

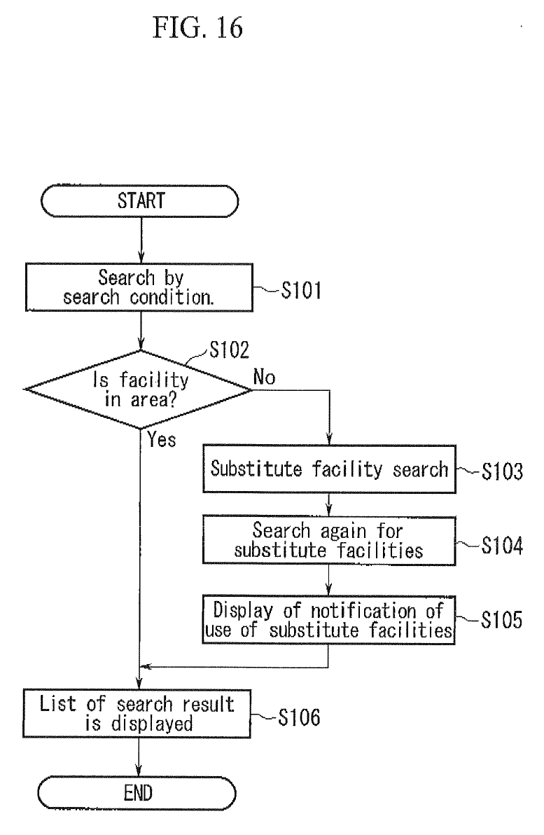

Next, in the case of there being no facility information that matches the search condition in the storing portion 8, the substitution process that is mainly performed by the substitute facility searching portion 26 shall be described referring to the display examples of FIGS. 2 to 4, FIG. 14, FIG. 15, and the flowchart of FIG. 16. Note that in this substitution process, the case of the aforementioned first search condition button 51 being selected and the determination input by the user shall be used as an example.

First, in Step S101 when the first search condition button 51 (refer to FIG. 2) is selected and the determination input by the user, the facility information searching portion 25 searches the stored information of the facility information storing portion 21 for facility information that matches the search condition that has been allocated to the first search condition button 51. Note that during this search, the message “Search in Progress” is displayed (refer to FIG. 3).

In Step S102, it is determined whether or not the facility “Aoyama Oil” that is the search object is in the area that has been set as the search method, that is, the vicinity of the current position.

In the case of the determination result in Step S102 being “YES” (there is a search object facility), the process proceeds to Step S106 to perform a list display of the search result (refer to FIG. 4), and the execution of this routine is once ended.

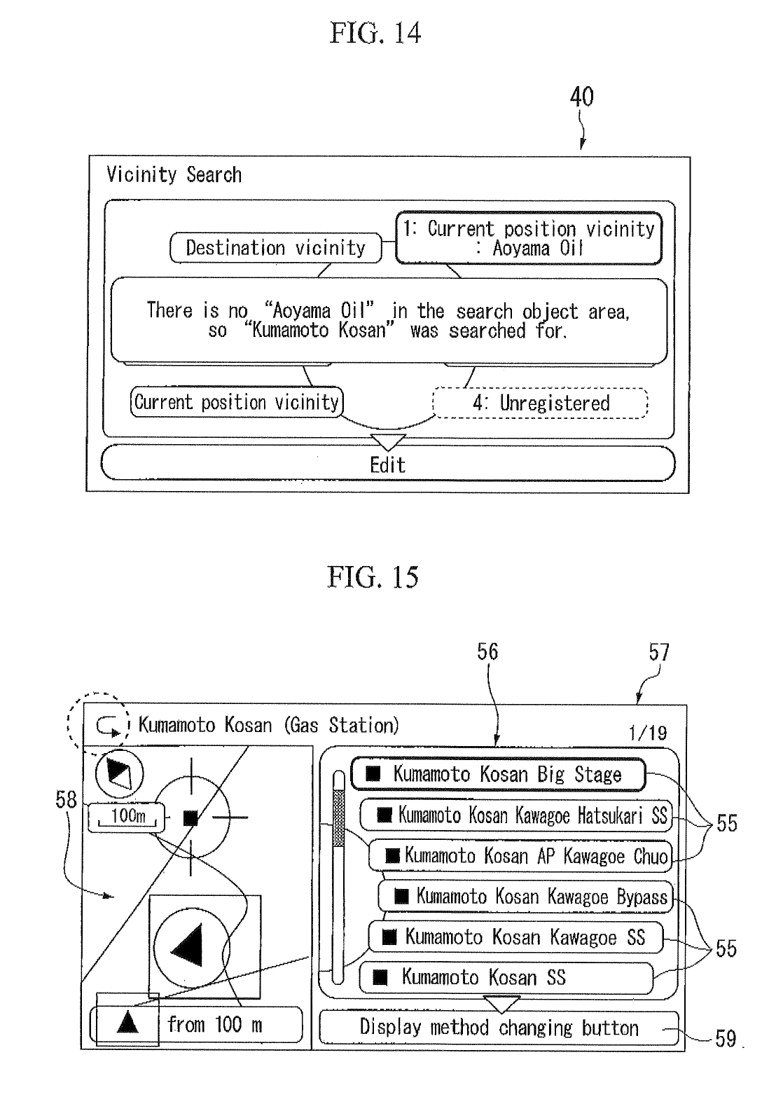

In the case of the determination result in Step S102 being “NO” (there is no search object facility), the process proceeds to Step S103 to perform substitute facility searching, and the process then proceeds to Step S104. Here, the substitute facility in this process is a facility of a name (brand, store name, etc.) other than “Aoyama Oil” and that belongs to the same large classification “gas station”. For example, “Kumamoto Kosan” and the like that is shown in the result display screen 57 of FIG. 14 and FIG. 15 are retrieved as substitute facilities. Note that in the case of many names being retrieved as substitute facilities, they may be arranged by an appropriate method such as the frequency of use, alphabetical order, number existing in the area, or the like.

In Step S104, the substitute facilities, that is, brands, that were retrieved in Step S103 are searched again with the search condition of area “vicinity of the current position”. At this time, in Step S100, a message to the effect that a search was conducted again for substitute facilities is displayed as shown in FIG. 14 to serve as a notification of the use of a substitute facility. Thereafter, the process proceeds to the aforementioned Step S106 in which a list of the results retrieved as substitute facilities is displayed in the result display screen 57, and the execution of this routine is once ended.

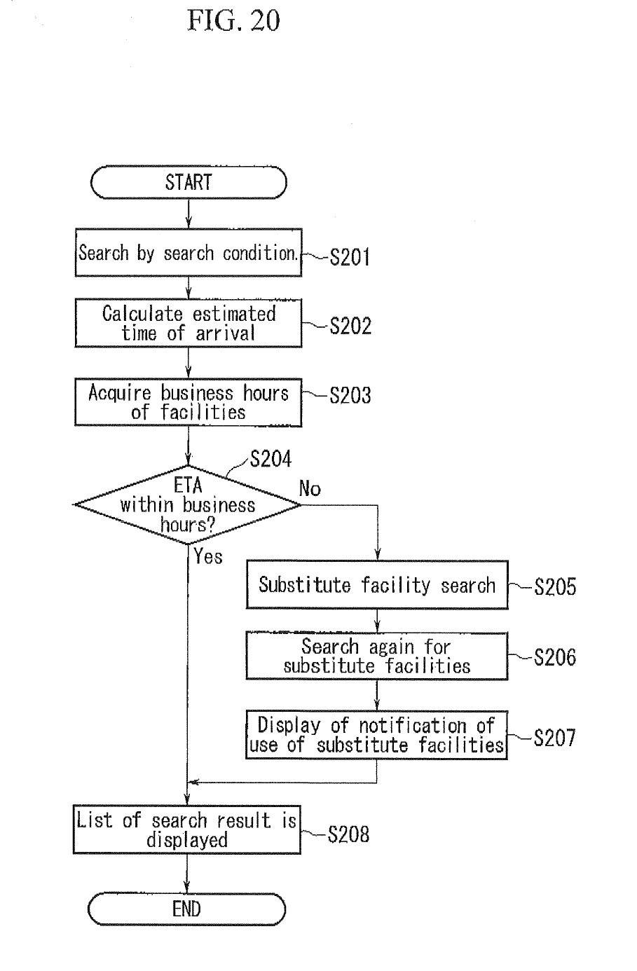

Note that among the search conditions described in the flowchart of FIG. 16 mentioned above, the case was described of searching again for substitute facilities by fixing the search method condition and searching for a different search object condition. In place of or in addition to that, for example, searching again may be performed by for example fixing the search object condition and setting a different search method condition, that is, searching again for facilities of a different area as substitute facilities (the same applies to the case of the process shown in FIG. 20 below).

### [Substitution Process Based on Business Hours]

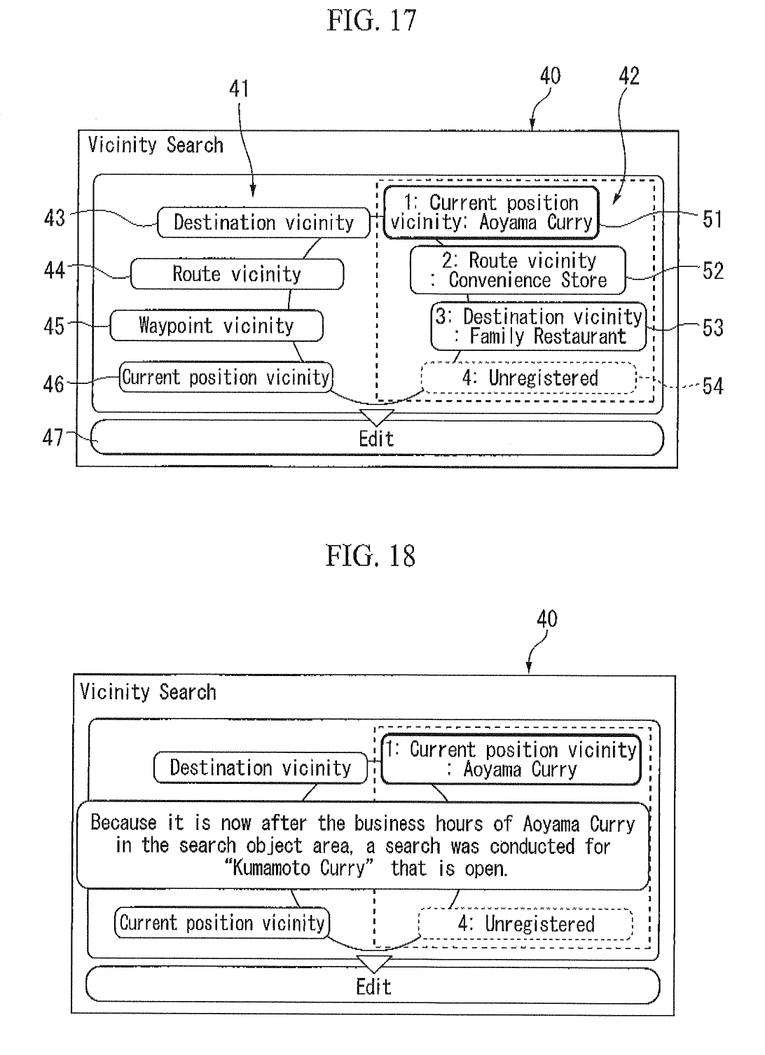

Next, the case of the selection setting that considers the determination result of the business hours determining portion 28, mainly a substitution process based on business hours that is performed by the substitute facility searching portion 26, shall be described with reference to the display examples of FIG. 2, FIG. 3, FIG. 17 to FIG. 19, and the flowchart of FIG. 20. Note that in this process based on business hours, the case in which the first search condition button 51, in which the search method “vicinity of the current position” and the search object “Aoyama Curry” are assigned as search conditions, is selected and determined by the user shall be described as an example.

First, in Step S201, when the first search condition button 51 (refer to FIG. 17) is selected and this determination is input by the user, the facility information searching portion 25 searches for facility information that matches the search condition assigned to the first search condition button 51 from the stored information of the facility information storing portion 21.

In Step S202, based on the search result, the estimated time of arrival at each of the facilities that were retrieved is calculated by the estimated time of arrival calculating portion 30.

Meanwhile, in Step S203, based on the search result the business hours of each facility are acquired.

In Step S204, it is determined whether or not the estimated time of arrival at each facility is within the respective business hours thereof.

In the case of the determination result in Step S204 being “YES” (within business hours), the process proceeds to Step S208, in which the search result of facilities that can be arrived at within business hours are listed, and then the execution of this routine is once ended.

On the other hand, in the case of the determination result in Step S204 being “NO” (outside business hours), the process proceeds to Step S205.

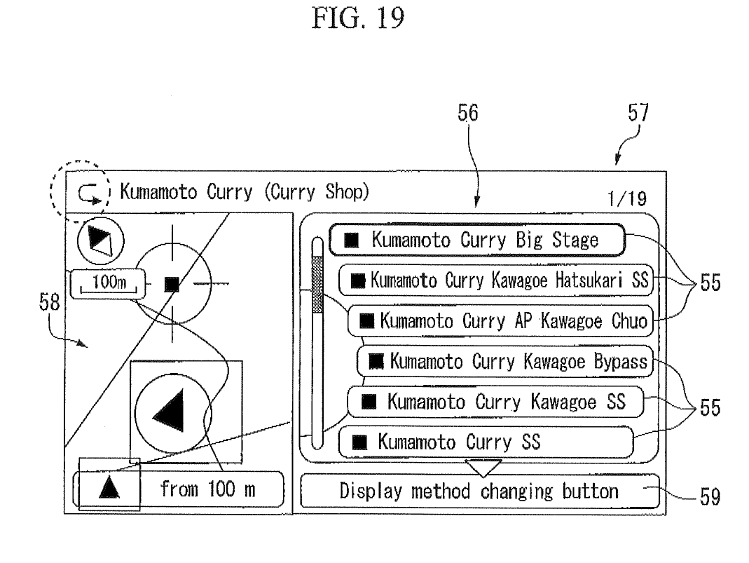

In Step S205, the search for a substituted facility is performed, and the process proceeds to Step S206. Here, the substitute facility in this process is a facility that is among facilities that can be arrived at within business hours and whose search object condition is of a name (brand, store name, etc.) other than “Aoyama Curry” and belongs to the same large classification “curry shop”, and for example, is “Kumamoto Curry” that is shown in FIG. 18 and FIG. 19. Note that similarly to the substitution process based on the aforementioned search condition, in the case of many names being retrieved as substitute facilities, they may be arranged by an appropriate method such as the frequency of use, alphabetical order, number existing in the area, or the like.

In Step S206, the substitute facilities, that is, brands of substitute facilities, that were retrieved in Step S205 are searched again with the search condition of area “vicinity of the current position”. At this time, in Step S207, similarly to the aforementioned Step S105, a notification is displayed of the use of substitute facilities shown in FIG. 18. Thereafter, the process proceeds to the aforementioned Step S208 in which a list of the results retrieved as substitute facilities is displayed in the result display screen 57 (refer to FIG. 19), and the execution of this routine is once ended.

Note that in the description of the flowchart of FIG. 20 mentioned above, similarly to the case of FIG. 16, the case was described of searching again for substitute facilities by fixing the search method condition and searching for a different search object condition. In place of or in addition to that, for example, searching again may be performed by for example fixing the search object condition and setting a different search method condition, that is, having facilities of a different area serve as substitute facilities.

According to the aforementioned first embodiment, just by combining the search method (area) and the search object (brand) with the search condition setting portion 9 to set a specified search condition and selecting this set search condition, it is possible to search for a waypoint and a route based on a search condition. For this reason, particularly in the case of a user's needs being made explicit, it is possible to reduce the amount of operation during searching. Also, since the search condition includes the search object and the search method, it is possible to search for only a facility in a desired area as a waypoint. As a result, it is possible to accurately and rapidly search for a waypoint and the route thereof that are more in accordance with the user's needs.

Also, as a result of searching with the facility information searching portion 25, in the case of there being no facilities that agree with the search condition in the facility information that is stored in the facility information storing portion 21, it is possible to search for facility information of facilities that can by substituted by the substitute facility searching portion 26, for example, facility information of facilities in another area near the route until the destination, or facilities of a similar genre, and it is possible to search for a waypoint and route with the route searching portion 5 based on this retrieved substitute facility information. That is, in the present embodiment, even in the case of there not being a facility that matches the user's needs, it is possible to accurately and rapidly search for a facility that is closest to the user's needs and set a route with that facility as a waypoint.

Moreover, based on the estimated time of arrival at a waypoint calculated by the estimated time of rival calculating portion 30 and the business hours information of the facility stored in the business hours storing portion 22, in the case of the business hours determining portion 28 determining that a facility cannot be arrived at during the business hours of the facility, the substitute facility searching portion 26 searches, for example, for a facility that can be arrived at during business hours as a substitute facility. Based on this search result, it is possible to set a waypoint and a route thereof with the route searching portion 5. That is, in the present embodiment, it is possible to perform setting of a waypoint that corresponds to the business hours of the facility, and as a result, it is possible to achieve an improvement of the merchantability.

Furthermore, in the present embodiment, it is possible to switch the search method that is the area to be searched via the search area switching portion 12. As a result of readily switching the search method that is set as the search condition to a desired search method, it is possible to achieve a further improvement of the merchantability.

Next, a first modification to a third modification of the vehicle navigation device in accordance with the first embodiment described above shall be described with reference to the drawings. Note that the first modification to third modification are constituted so as to more readily perform editing of search conditions in the first search condition button 51 to the fourth search condition button 54 in accordance with the first embodiment mentioned above. The points of difference shall be described using FIG. 1 of the first embodiment and denoting the same portions by the same reference numbers.

### [First Modification]

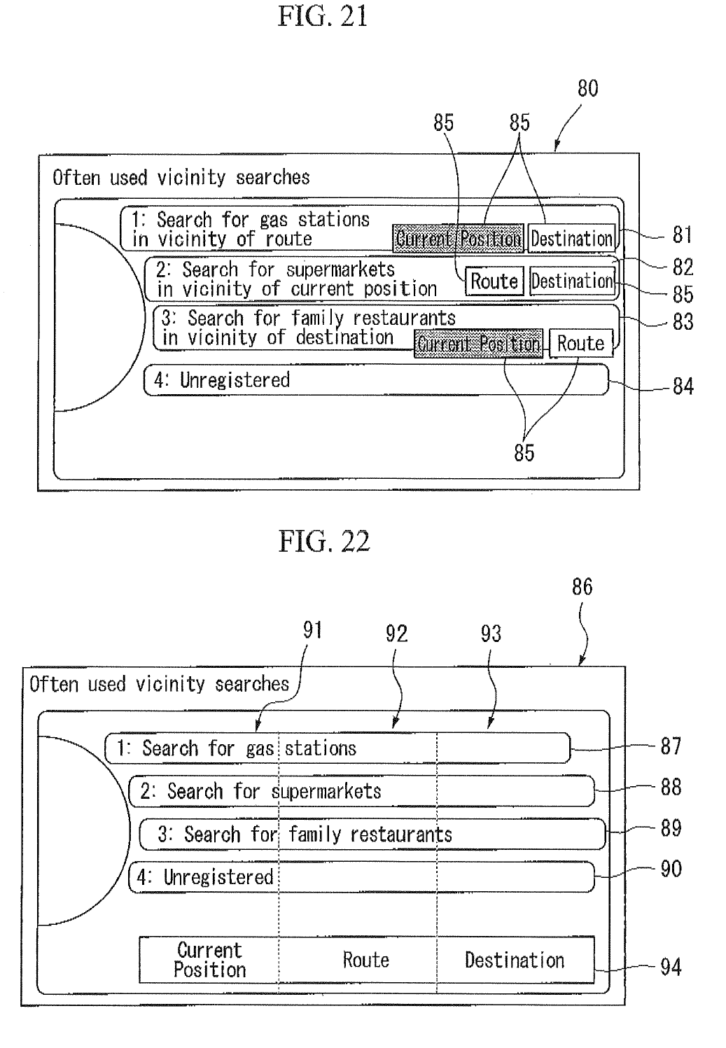

FIG. 21 is a drawing that shows an edit screen 80 that corresponds to FIG. 7 to FIG. 10 of the aforementioned first embodiment. This edit screen 80 is an edit screen of the discrete button display format, and in the case of the edit button 47 of the aforementioned vicinity search screen 40 (refer to FIG. 5) being selected and determined by the user, is displayed on the display 6.

In the first modification, the edit screen 80 is provided with a first search condition button 81 to a fourth search condition button 84. In the case of the edit screen 80 shown in FIG. 21, the search condition “vicinity of route”+“gas station” is assigned to the first search condition button 81. The search condition “vicinity of current position”+“supermarket” is assigned to the second search condition button 82. The search condition “vicinity of destination”+“family restaurant” is assigned to the third search condition button 83. In addition, for the fourth search condition button 84, a search condition has not set (that is, is unregistered).

Two area change buttons 85 for easy switching of the search method are provided in each of the first search condition button 81 to the third search condition button 83 to which search conditions have been assigned. Search methods other than the search method that has been set to the search condition are assigned to these two change buttons 85. For example, in the case of the first search condition button 81 of FIG. 21, “vicinity of route” is set as the search method condition. Therefore, “vicinity of current position” and “vicinity of destination” are assigned to the area change buttons 85, and “current position” and “destination” are displayed on the area change buttons 85 so that the respective conditions are distinguishable to the user.

Here, when the “current position” area button 85 is selected and determined, the search method that is set to the first search condition button 81 is changed to “vicinity of current position”. In the area change button 85, instead of “vicinity of current position”, “vicinity of route” is newly assigned. In this case, “route” and “destination” are displayed on the area change buttons 85.

Note that the description was given using the first search condition button 81 as an example, but the same applies to the second and third search condition buttons 82 and 83. Also, in the case of the fourth search condition button 84, if a search condition is registered, then the area change buttons 85 will be displayed, so that easy switching of the search method becomes possible (hereinbelow, the same applies to the second and third modifications).

Moreover, with respect to the search condition buttons, the case was described of providing two area change buttons 85, but it is possible to provide two or more of the area change buttons 85 to at least one search condition button in accordance with the kind of condition that is set in advance.

By constituting in the manner of the aforementioned first modification, it is possible to easily change the search method of the search condition.

### [Second Modification]

FIG. 22 shows the edit screen 86 of the second modification. In the edit screen 86 of this second modification, a gradation format is adopted, and a touchpad (not illustrated) is provided on the display 6 as the operation input portion 3.

On the edit screen 86, a first search condition button 87 to a fourth search condition button 90 are displayed in which only the search objects of the respective search conditions are displayed. The first search condition button 87 to the fourth search condition button 90 have a long shape along the lengthwise direction of the screen. The color schemes of the first search condition button 87 to the third search condition button 89 may be mutually different, at least two may be the same (for illustration convenience, they are shown in black and white). In each of the search condition buttons 87 to 89, there is a gradation in which the color is deepest on one end side and becomes lighter the further to the other end side. The first search condition button 87 to the third search condition button 89 have three regions that are divided along the lengthwise direction. In the present example, the three regions consist of a current position region 91, a route region 92, and a destination region 93, and the positions of these regions can be distinguished by the shade of the gradation, that is, a dark color, a medium color, and a light color. Also, in FIG. 22, a legend display 94 of the division of the regions by gradation appears at the lower portion of the edit screen 86.

Here, when a user's operation finger contacts the first search condition button 87 of the current position region 91 shown in FIG. 22, for example, a search condition is set by the search condition setting portion 9 with the search method being “vicinity of the current position” and the search object being “gas station.” The facility information corresponding to this search condition is searched from the stored information in the storing portion 8. In a similar fashion, when an operation finger contacts the route region 92, the search method of the search condition is set to “route vicinity.” When an operation finger contacts the destination region, the search method of the search condition is set to “vicinity of the destination” (the same applies for the second search condition button 88 and the third search condition button 89). Note that no gradation is shown on the (unregistered) fourth search condition button 90 in which a search condition has not been set). By constituting in the manner of the second modification, simply by changing the position at which a user's operation finger contacts the first search condition button 87 to the third search condition button 89, it is possible to readily change the search method.

### [Third Modification]

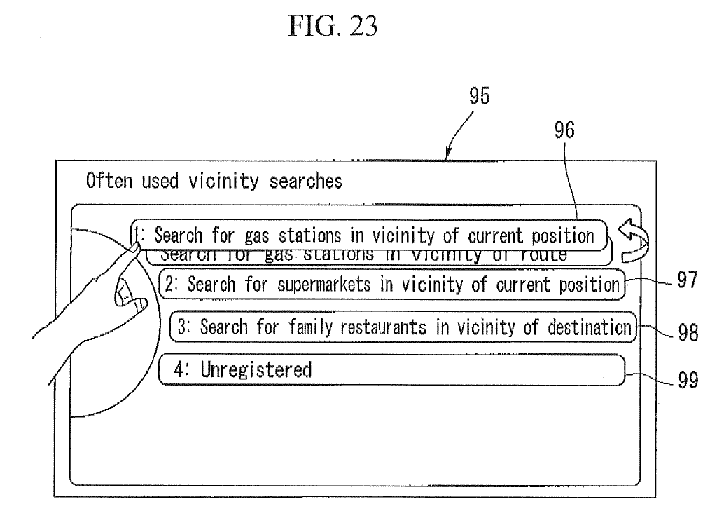

FIG. 23 shows an edit screen 95 in the third modification. The edit screen 95 of the third modification adopts the tap method, and is provided with a first search condition button 96 to a fourth search condition button 99 that have a long shape along the lengthwise direction of the screen. Similarly to the second modification, a touch panel (not illustrated) is arranged as the operation input portion 3 on the display 6.

In the edit screen 95 of the third modification, a user performs a long push or a double-tap on the touch panel at the first search condition button 96 to the third search condition button 98. Thereby, only the search method of the search condition that has been set in the first search condition button 96 to the third search condition button 98 is replaced in turn by rotating in the direction of the arrow in the drawing. By constituting in the manner of the third modification, it is possible to easily change the search method while preventing an operational error.

Next, the vehicle navigation device in accordance with the second embodiment of the present invention shall be described with reference to the drawings. Note that in the second embodiment, as for the vehicle navigation device 101, a constitution that changes the display of buttons for performing selection/determination of the search condition in accordance with the arrival cost of the route to the destination including a waypoint and buttons for changing the search method is added to the constitution of the vehicle navigation device 1 in accordance with the first embodiment mentioned above. In the description below, the portions that are the same as the first embodiment shall be denoted by the same reference numerals, and the points of difference shall be described in detail.

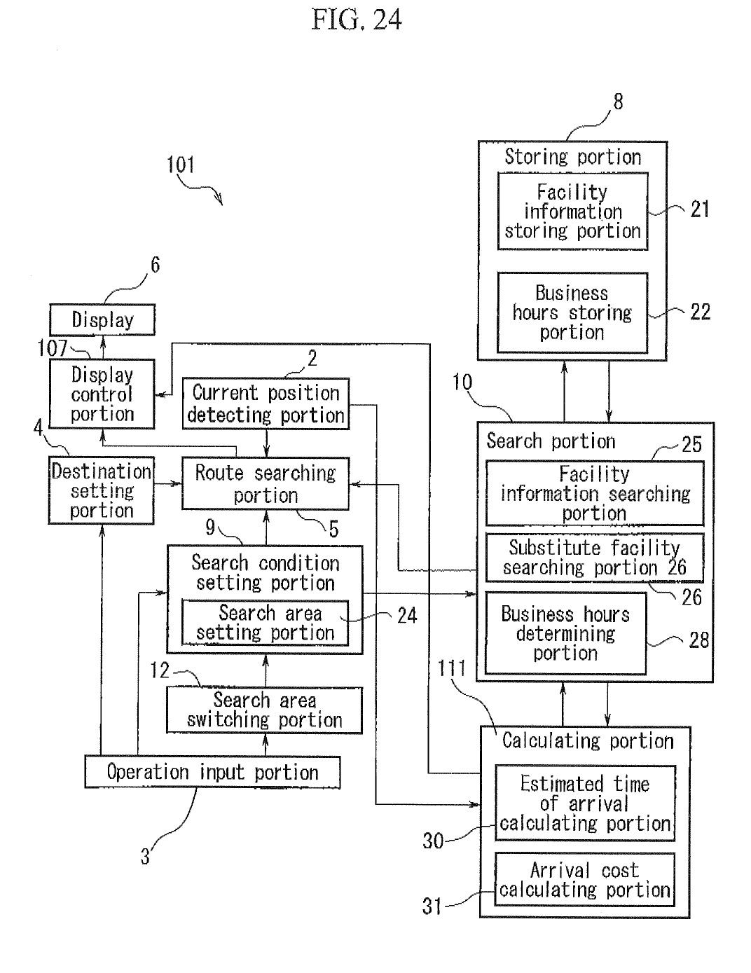

As shown in FIG. 24, in the second embodiment, the vehicle navigation device 101 is provided with the current position detecting portion 2, the operation input portion 3, the destination setting portion 4, the route searching portion 5, the display 6, a display control portion 107, the storing portion 8, Me search condition setting portion 9, the search portion 10, a calculating portion 111, and the search area switching portion 12. Note that the current position detecting portion 2, the operation input portion 3, the destination setting portion 4, the route searching portion 5, the display 6, the storing portion 8, the search condition setting portion 9, the search portion 10, and the search area switching portion 12 have the same composition as the first embodiment mentioned above, and so a detailed description thereof shall be omitted.

The calculating portion 111 is equipped with the estimated time of arrival calculating portion 30 mentioned above and an arrival cost calculating portion 31. The arrival cost calculating portion 31 is constituted so as to calculate the arrival cost based on the calculation result of the estimated time of arrival calculating portion 30. Information of the arrival cost that is calculated by the arrival cost calculating portion 31 is output to a display control portion 107. Thereby, in the display control portion 107 to which the arrival cost information has been input, display control is performed by altering the color or shade to emphasize a ranking from the one with a low arrival cost. Here, arrival cost is calculated based not only on the length of the route from the current position to the destination, but also on various pieces of information such as congestion information, number of traffic signals, and number of lanes of a road. Generally, when the arrival cost is high, it is presumed that the time to arrival at the destination will be long, and when the arrival cost is low, it is presumed that the time to arrive at the destination will be short.

The display control portion 107 performs display control of the display 6 based on the output of the route searching portion 5 and the calculating portion 11. The current position of the vehicle, the destination, and the route between the current position and the destination are superimposed on a map of an appropriate scale and displayed on the display 6 that is controlled by the display control portion 107. Also, the display control portion 107 respectively highlights the search method in which the arrival cost is relatively high and the search method in which the arrival cost is relatively low based on the calculation result of the arrival cost calculating portion 31. For example, a first search condition button 112 to a fourth search condition button 115 in which search conditions have been set, and area change buttons 116 that are displayed on each button are colored so that the search method with the lowest arrival cost is for example “blue”, while the search method with the highest arrival cost is “red”.

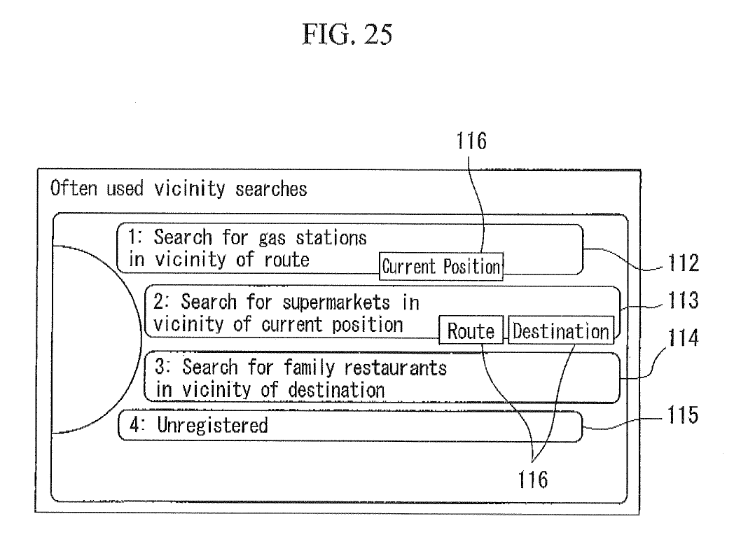

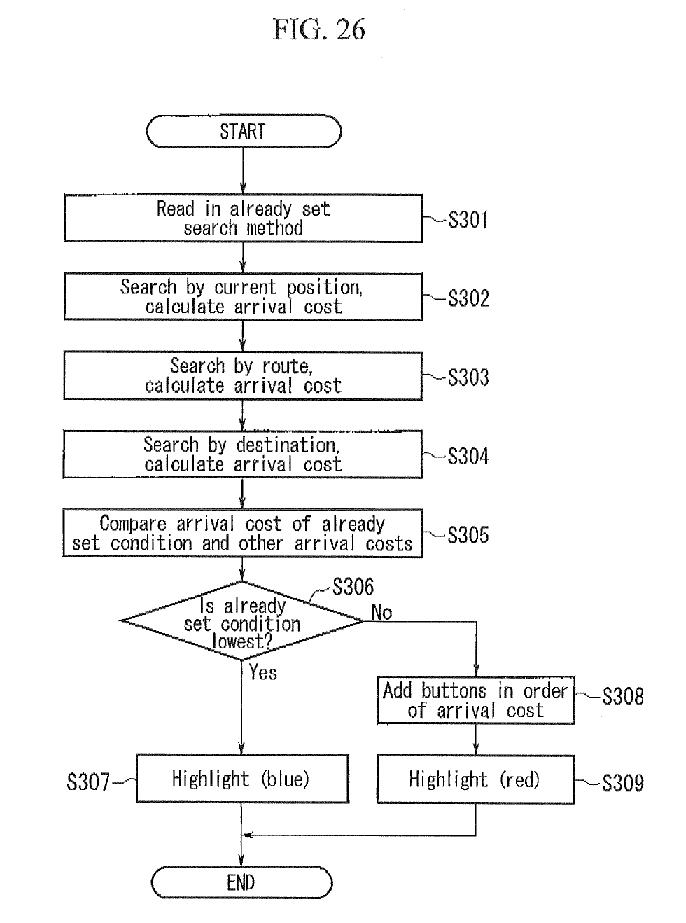

In the second embodiment, the vehicle navigation device 101 is provided with the constitution mentioned above. Next, the highlighting process of the vehicle navigation device 101 will be described with reference to the flowchart of FIG. 26 and FIG. 25. Note that since this highlighting process is individually carried out on the first search condition button 112 to the fourth search condition button 115, the description shall be given using the first search condition button 112 as an example.

### [Highlighting Process]

First, in Step S301, an already set search method is read into the display control portion 107 as the search condition for the first search condition button 112.

In Step S302, the arrival cost is calculated in the case of the search method being “vicinity of current position”.

In Step S303, the arrival cost is calculated in the case of the search method being “vicinity of route”.

In Step S304, the arrival cost is calculated in the case of the search method being “vicinity of destination”.

In Step S305, the arrival cost of the already set search method, and the arrival costs of the search methods that were not set as the search condition among the arrival costs calculated in Steps S302 to S304 (other arrival costs) are compared.

In Step S306, it is determined whether or not the arrival costs of the other search methods are lower than the arrival cost of the already set search method.

If the determination result in Step S306 is “YES” (low), the process proceeds to Step S307, and the first search condition button 112 is highlighted with a color scheme, for example, blue, showing that the arrival cost is the lowest, and the execution of this routine is once ended.

If the determination result in Step S306 is “NO” (high), the process proceeds to Step S308, and search method area change buttons 85 are added and arranged in the order of arrival cost (for example, arranged sequentially from the left). In this case, the search method change button 116 with the lowest arrival cost is highlighted with a color scheme that shows that its arrival cost is the lowest (for example, blue).

In Step S309, the first search condition button 112 is highlighted with a color scheme, for example, red, showing that the arrival cost is the highest, and the execution of this routine is once ended.

That is, in the case of the first search condition button 112 of FIG. 25, the arrival cost of “vicinity of the current position” is lower than “vicinity of route” of the search method that is currently set. For this reason, the area change button 116 to change the search method to “vicinity of the current position” is displayed. Moreover, this area change button 116 is highlighted with a color scheme (for example, blue) that indicates that the arrival cost is the lowest.

Also, in the case of the second search condition button 113 of FIG. 25, the arrival cost has the relation of “vicinity of current position”>“vicinity of destination”>“vicinity of route.” For this reason, the second search condition button 113 is highlighted with a color scheme (for example, red) that shows that the arrival cost is high. Moreover, the “route vicinity” area change button 116 and the “vicinity of destination” area change button 116 are displayed above the second search condition button 113 in that order from the left. The “route vicinity” area change button 116, which has the lowest arrival cost, is highlighted with a color scheme (for example, blue) that indicates that the arrival cost is the lowest.

According to the aforementioned second embodiment, when there is a search method that is more appropriate than the search method that is currently set to the first search condition button 112, the area change buttons 116 are arranged in the order of arrival cost, and the change button 85 with the lowest arrival cost is highlighted with a color scheme. For that reason, the user can readily recognize a search method that is more appropriate than the current one, and as a result, it is possible to efficiently stop by a waypoint. Also, in the case of the arrival cost of the search method that is currently set being the highest, by highlighting the first search condition button 112 to show that the arrival cost is high, the user can be easily made to recognize that it is a non-recommended search method, and thus prompted to change the search method.

Note that in the second embodiment described above, the description was made mainly regarding highlighting of the first search condition button 112, but highlighting of the second search condition button 113 and the third search condition button 114 is the same. Also, regarding the fourth search condition button 115, since the search condition is yet to be set (unregistered), highlighting is not performed until a search condition has been set.

Next, the vehicle navigation device in accordance with the third embodiment of the present invention shall be described with reference to the drawings. Note that in a vehicle navigation device 201 of this third embodiment, a constitution that sets the search method based on an input of the timing of stopping by a waypoint is added to the constitution of the vehicle navigation device 1 in accordance with the first embodiment mentioned above. In the description below, the portions that are the same as the first embodiment shall be denoted by the same reference numerals, and the points of difference shall be described in detail.

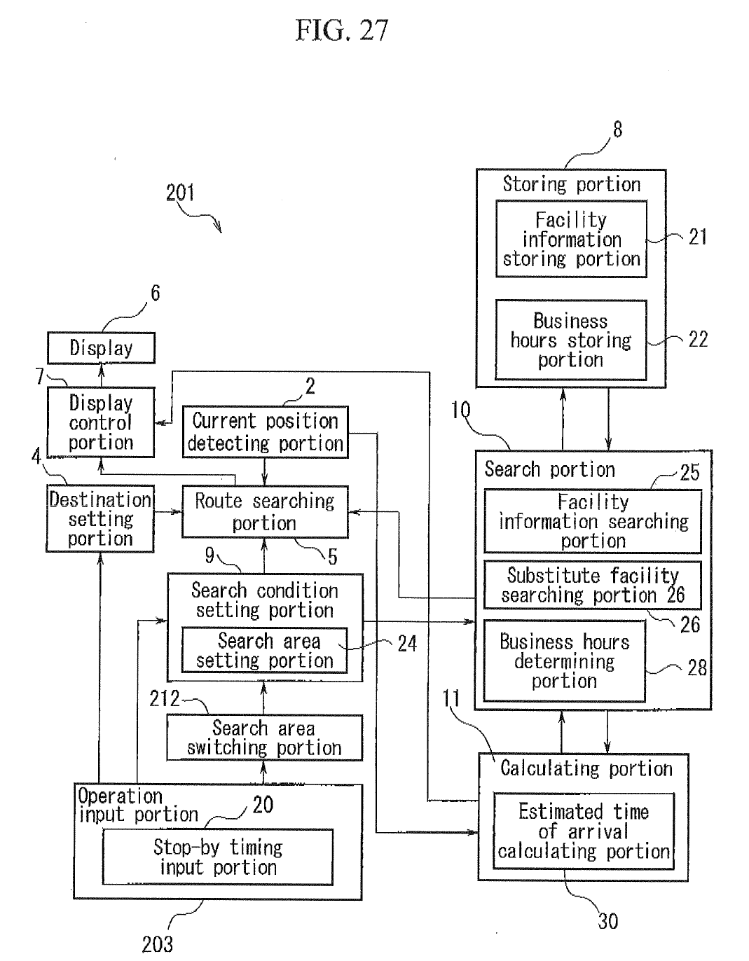

As shown in FIG. 27, the vehicle navigation device 201 of the third embodiment is provided with the current position detecting portion 2, an operation input portion 203, the destination setting portion 4, the route searching portion 5, the display 6, the display control portion 7, the storing portion 8, the search condition setting portion 9, the search portion 10, the calculating portion 11, and a search area switching portion 212. Note that the current position detecting portion 2, the destination setting portion 4, the route searching portion 5, the display 6, the storing portion 8, the search condition setting portion 9, and the search portion 10 have the same composition as the first embodiment mentioned above, and so a detailed description thereof shall be omitted.

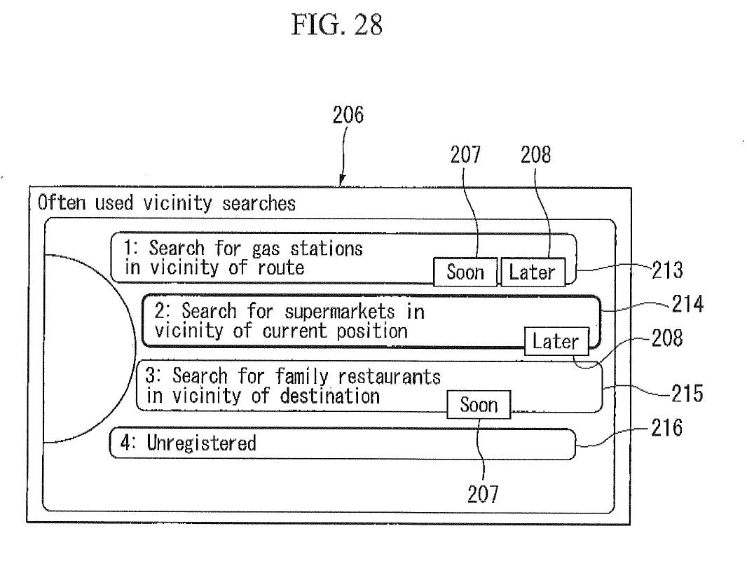

The operation input portion 203 is one that adds a stop-by timing input portion 20 to the constitution of the operation input portion 3 of the first embodiment mentioned above. With the stop-by timing input portion 20, a user is able to input the timing of stopping by a waypoint, such as “soon”, “later” or the like. For example, as shown in FIG. 28, it can be displayed as a soon button 207 and a later button 208 on the first search condition button 213 to the third search condition button 215 whose search conditions are already set.

The search area switching portion 212 switches (converts) the input result to the stop-by timing input portion 20 to a predetermined search method that corresponds to the input result. More specifically, when the soon button 207 is selected and the determination is input, the search area switching portion 212 switches the search method to “vicinity of current position”. Also, when the later button 208 is selected and the determination is input, the search area switching portion 212 switches the search method to “vicinity of destination”. The switch result is output to the search area setting portion 24 of the search condition setting portion 9. Thereby, a search condition in which the search method is temporarily altered is output from the search area setting portion 24 to the search portion 10, and based on this search condition, a search for a facility that is a waypoint is conducted. Note that when the facility search ends based on the switched result of the search area switching portion 212, the search method returns to the original set contents.

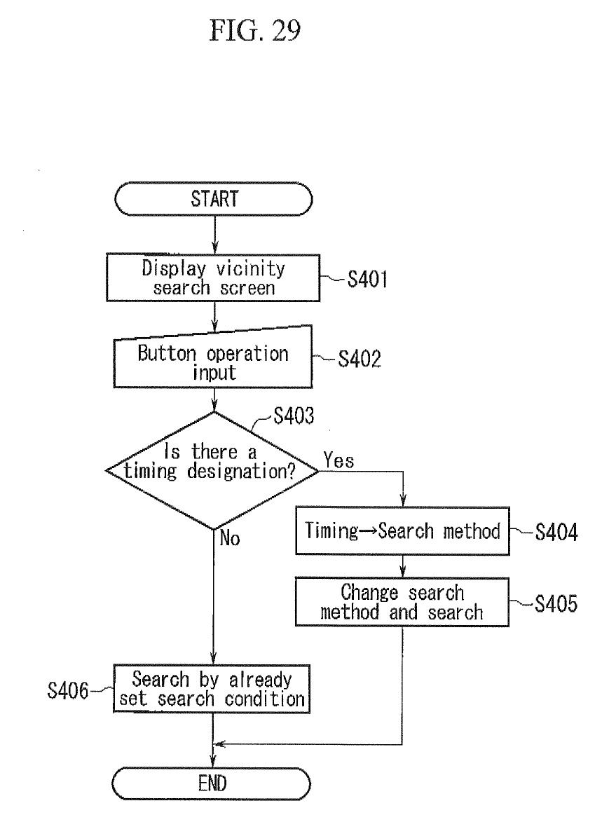

In the third embodiment, the vehicle navigation device 201 is provided with the aforementioned constitution. Next, the search method conversion process based on the stop-by timing of this vehicle navigation device 201 shall be described with reference to FIG. 28 and the flowchart of FIG. 29.

### [Search Method Conversion Process Based on Stop-By Timing]

First, in Step S401, a vicinity search screen 206 shown in FIG. 28 is shown on the display 6. In Step S402, it waits for a button operation by the user, and the process proceeds to Step S403.

Here, in the vicinity search screen 206 of FIG. 28 are displayed the first search condition button 213 in which the search condition of search method “vicinity of route” and search object “gas station” has been set, the second search condition button 214 in which the search condition of search method “vicinity of the current position” and search object “supermarket” has been set, the third search condition button 215 in which the search condition of search method “vicinity of the destination” and search object “family restaurant” has been set, and the fourth search condition button 216 in which a search condition has not been set (unregistered). Also, at least one of the soon button 207 and the later button 208 is displayed on the first search condition button 213 to the third search condition button 215. Note that since “vicinity of the current position” is set as the search method in the second search condition button 214, the soon button 207 is not displayed. Also, since “vicinity of the destination” is set as the search method in the third search condition button 215, the later button 208 is not displayed.

In Step S403, it is determined whether or not there is a timing designation in the content of the operation input by the user, that is, operation of the soon button 207 or the later button 208.

If the determination result in Step S403 is “NO” (no designation), the process proceeds to Step S406, a facility search is performed by the search condition that has already been set, and the execution of this routine is once ended.

If the determination result in Step S403 is “YES” (a designation exists), the process proceeds to Step S404, in which the timing is switched to a search method, and the process proceeds to Step S405.

In Step S405, the search method of the search condition is temporarily changed to the search method that was switched in Step S404, the facility search is performed, and the execution of his routine is once ended.

According to the third embodiment of the present invention, as a result of the user inputting “soon”, “later” or the like via the stop-by timing input portion 20 as the timing to stop by a facility, the search method that corresponds to this input result can be automatically set by the search area setting portion 24 as the search method of the search condition. For this reason, for example, in the case of the user considering to buy food such as fish or cake that is difficult to preserve or flowers or the like directly before arriving at the destination, it is possible to temporarily change only the search method without altering the settings of the search conditions that are set in the first search condition button 213 to the fourth search condition button 216. Thereby, it is possible to improve the flexibility of searching for facilities and achieve an improvement in usability.

Note that there are no particular restrictions on the constitution of the third embodiment described above. For example, it may be constituted so as to select a search method by speech such as “soon” or “later” or the like within a predetermined time after the selection/determination input of a registration button not shown, using a speech recognition device.

While embodiments of the invention have been described and illustrated above, it should be understood that these are exemplary of the invention and are not to be considered as limiting. Additions, omissions, substitutions, and other modifications can be made without departing from the spirit or scope of the present invention.

Accordingly, the invention is not to be considered as being limited by the foregoing description, and is only limited by the scope of the appended claims.

What is claimed is:

1. A vehicle navigation device comprising:
a destination setting means that sets a destination;
a route searching means that searches for a route to the destination that has been set by the destination setting means; and
a search condition setting means that sets a specified search condition from a plurality of conditions that include a type of facility serving as a search object and an area serving as a search object,
wherein the route searching means, in the case of an input operation of a specified search condition being performed by a user, searches for a waypoint and a route thereof based on the search condition.

2. The vehicle navigation device according to claim 1, further comprising:
a facility information storing means in which facility information that includes information of the types of facilities and the area in which the facilities are located is stored beforehand;
a facility information searching means that searches for facility information that matches the input search condition from stored information of the facility information storing means; and
a substitute facility searching means that, in the case of there being no facility information that matches the search condition, searches for facility information of a substitutable facility from the stored information of the facility information storing means,
wherein the route searching means searches for a waypoint and a route thereof based on the substitute facility information that is retrieved by the substitute facility searching means.

3. The vehicle navigation device according to claim 2, further comprising:
an estimated time of arrival calculating means that calculates the estimated time of arrival to a waypoint that is retrieved by the route searching means;
a business hours storing means in which business hours information of facilities serving as a search object is stored in advance; and
a business hours determining means that determines whether or not it is possible to arrive at a waypoint within the business hours of the facility, based on the estimated time of arrival that was calculated by the estimated time of arrival calculating means and the business hours information of the facility that is the search object stored in the business hours storing means,
wherein, in the case of being determined by the business hours determining means that it is not possible to arrive during business hours, the substitute facility searching means searches for facility information of a substitutable facility from the stored information of the facility information storing means, and
the route searching means sets a waypoint and the route thereof based on the facility information that is retrieved by the substitute facility searching means.

4. The vehicle navigation device according to claim 1, further comprising a search area switching means that switches the area to search for a facility.

5. The vehicle navigation device according to claim 3, further comprising:
an arrival cost calculating means that calculates arrival cost based on at least the estimated time of arrival, and
a display control means that highlights a specified area condition based on the arrival cost calculated by the arrival cost calculating means.

6. The vehicle navigation device according to claim 1, further comprising:
a stop-by timing input means that enables input of a timing of stopping by a facility that is the search object; and
a search area setting means that sets the area of the search condition based on the input result to the stop-by timing input means.
